(19) United States
(12) Patent Application Publication
(10) Pub. No.: US 2008/0260525 A1
(43) Pub. Date: Oct. 23, 2008

(54) Device For Supplying Pulse Width-Modulated Output Pulses For the Motor of a Fan

(76) Inventor: Erich Maier, Wurzburg (DE)

Correspondence Address: BAKER BOTTS L.L.P.;PATENT DEPARTMENT, 98 SAN JACINTO BLVD., SUITE 1500, AUSTIN, TX, 78701-4039, US

(21) Appl. No.: 12/089,850

(22) PCT Filed: Sep. 7, 2006
(86) PCT No.: PCT/EP2006/066097

§ 371 Date: Apr. 10, 2008

(30) Foreign Application Priority Data
Oct. 12, 2005 (DE) 10 2005 048 885.4

(51) Int. Cl. F04D 29/40; H02P 7/29

(52) U.S. Cl. 415/182.1; 318/3

(57) ABSTRACT

A device for supplying pulse width-modulated output pulses for the motor of a fan has an arithmetic unit and at least one final output stage. The arithmetic unit and the final output stage are disposed in a rod-shaped housing. A fan encompasses a device that is located in a rod-shaped housing and is used for supplying pulse width-modulated output pulses.

### CROSS-REFERENCE TO RELATED APPLICATIONS

This application is a U.S. national stage application of International Application No. PCT/EP2006/066097 filed Sep. 7, 2006, which designates the United States of America, and claims priority to German application number 10 2005 048 885.4 filed Oct. 12, 2005, the contents of which are hereby incorporated by reference in their entirety.

### TECHNICAL FIELD

The invention relates to a device for providing pulse-width-modulated power pulses for the motor of a fan.

### BACKGROUND

It is already known to make pulse-width-modulated power pulses available to the motor of a fan, the pulse-width-modulated power pulses being generated using a processing unit and at least one power output stage. FIG. 1 shows various embodiments according to the prior art.

FIG. 1a shows a fan which has a fan housing 1, a fan wheel 2 and a motor which is provided for driving the fan wheel and is disposed in a motor housing 3. The motor is controlled by means of pulse-width-modulated power pulses. The device 8 which provides said power pulses is likewise disposed within the motor housing 3. The motor housing 3 is connected to a plug connector 5 by way of a connecting cable 4. Said plug connector 4 is provided for establishing electrical contact with a mating connector 6 of the onboard electrical system 7 of a vehicle. Control signals for the fan are generated in a control device of the vehicle and transmitted to the motor housing 3 via the vehicle electrical system 7, the mating connector 6 and the connecting cable 4.

FIG. 1b shows a fan which has a fan housing 1, a fan wheel 2, a motor which is provided for driving the fan wheel and is disposed in a motor housing 3, and a device 8 for providing pulse-width-modulated power pulses. In this arrangement the device 8 is connected to the motor housing 3 by way of a connecting cable 4a and to a plug connector 5 by way of a connecting cable 4b. The plug connector 5 is provided for establishing electrical contact with a mating connector 6 of the vehicle electrical system 7 of a vehicle.

FIG. 1c shows a fan which a fan housing 1, a fan wheel 2, a motor which is provided for driving the fan wheel and is disposed in a motor housing 3, and a device 8 for providing pulse-width-modulated power pulses. In this arrangement the device 8 is docked to the motor housing 3. The device 8 is also connected to a plug connector 5 by way of a connecting cable 4c. Said plug connector 5 is provided for establishing electrical contact with a mating connector 6 of the vehicle electrical system of a vehicle.

In all the above-described embodiments according to the prior art it is disadvantageous that relatively long connecting leads or connecting cables must be routed to the motor housing, which is positioned in the central area of the fan wheel. Said cable routing is generally implemented by way of one of the plastic struts that are provided between the motor housing and the fan housing. For this purpose said plastic strut is embodied as open on one side so that the connecting cable can be routed in the plastic strut. A disadvantage of using long connecting cables of this type is that the cable routing is complicated and unreliable. The cables are subject to conduction losses and chafing problems. Moreover a great deal of time and effort must be expended in terms of sealing at openings, welded joints and other contact points. Furthermore the above-described embodiments do not lend themselves to automation. In addition an antenna effect with high radiation occurs and susceptibility to irradiation is present.

### SUMMARY

According to an embodiment, a device for providing pulse-width-modulated power pulses for the motor of a fan, may comprise—a processing unit and—at least one power output stage, wherein the processing unit and the power output stage are arranged in a rod-shaped housing.

According to a further embodiment, the length of the rod-shaped housing may be equivalent to at least twice the width of the rod-shaped housing. According to a further embodiment, at least one of the narrow-side end areas of the housing may be provided with a plug connector which has a plug connector housing and plug connector contacts. According to a further embodiment, the plug connector housing may be part of the rod-shaped housing. According to a further embodiment, at least one of the narrow-side end areas of the housing may have an offset plug connector. According to a further embodiment, a stamped grid may be arranged in the rod-shaped housing and the plug connector contacts of the plug connector may be component parts of the stamped grid. According to a further embodiment, a stamped grid may be arranged in the rod-shaped housing and the plug connector contacts of the plug connector may be connected to the stamped grid. According to a further embodiment, the rod-shaped housing may have securing means on its outer circumference. According to a further embodiment, the securing means may be the plug connectors or latching means or securing brackets. According to a further embodiment, the rod-shaped housing may be provided with a metal sheath. According to a further embodiment, at least one additional component may be also contained in the rod-shaped housing. According to a further embodiment, one additional component may be an interference suppression choke. According to a further embodiment, one additional component may be an ohmic resistance and/or a relay.

According to another embodiment, a fan may comprise a motor, a fan wheel and a device for providing pulse-width-modulated power pulses comprising a processing unit and at least one power output stage, wherein the device for providing pulse-width-modulated power pulses is arranged in a rod-shaped housing.

According to a further embodiment, the length of the rod-shaped housing may be equivalent to at least twice the width of the rod-shaped housing. According to a further embodiment, at least one of the narrow-side end areas of the rod-shaped housing may be contacted to the motor housing without the use of a connecting cable. According to a further embodiment, the narrow-side end area of the rod-shaped housing contacted to the motor housing may have a plug connector which is directly contacted to a mating connector of the motor housing. According to a further embodiment, the motor may be positioned in the central area of the fan wheel and the rod-shaped housing may completely or largely span the impeller radius of the fan wheel. According to a further embodiment, the motor may be positioned in the central area of the fan wheel, the rod-shaped housing may be connected to a fixed extension piece and the rod-shaped housing together with the fixed extension piece connected thereto may span the impeller radius of the fan wheel. According to a further embodiment, the motor housing may be connected to the fan housing by means of struts and the rod-shaped housing serves as a strut. According to a further embodiment, the motor housing may be secured to the fan housing by means of a bracket and a fastening ring and the rod-shaped housing may be secured to the motor bracket and the fastening ring. According to a further embodiment, the rod-shaped housing may be connected to the motor bracket and the fastening ring by means of screws. According to a further embodiment, the rod-shaped housing may be provided with a metal sheath.

### BRIEF DESCRIPTION OF THE DRAWINGS

Further advantages of the invention will emerge from the explanation given thereof by way of example and with reference to the figures, in which:

FIG. 1 shows embodiments of conventional fans,

FIG. 2 is a schematic of a device according to an embodiment for providing pulse-width-modulated power pulses for the motor of a fan,

FIG. 3 is a schematic intended to elucidate a fan according to a first exemplary embodiment,

FIG. 4 is a schematic intended to elucidate a fan according to a second exemplary embodiment,

FIG. 5 is a schematic of a second embodiment of a device for providing pulse-width-modulated power pulses for the motor of a fan,

FIG. 6 is a schematic of a third embodiment of a device for providing pulse-width-modulated power pulses for the motor of a fan,

FIG. 7 is a schematic of a fourth embodiment of a device for providing pulse-width-modulated power pulses for the motor of a fan,

FIG. 8 is a schematic of a fifth embodiment of a device for providing pulse-width-modulated power pulses for the motor of a fan,

FIG. 9 is a schematic of a sixth embodiment of a device for providing pulse-width-modulated power pulses for the motor of a fan,

FIG. 10 is a schematic of a seventh embodiment of a device for providing pulse-width-modulated power pulses for the motor of a fan,

FIG. 11 is a schematic of an eighth embodiment of a device for providing pulse-width-modulated power pulses for the motor of a fan,

FIG. 12 is a schematic intended to elucidate an exemplary embodiment for connecting a device for providing pulse-width-modulated power pulses for the motor of a fan to the motor housing and the fan housing,

FIG. 13 is a schematic intended to elucidate securing means, and

FIG. 14 is a schematic of a fan in which the rod-shaped housing is provided as a replacement for a motor strut.

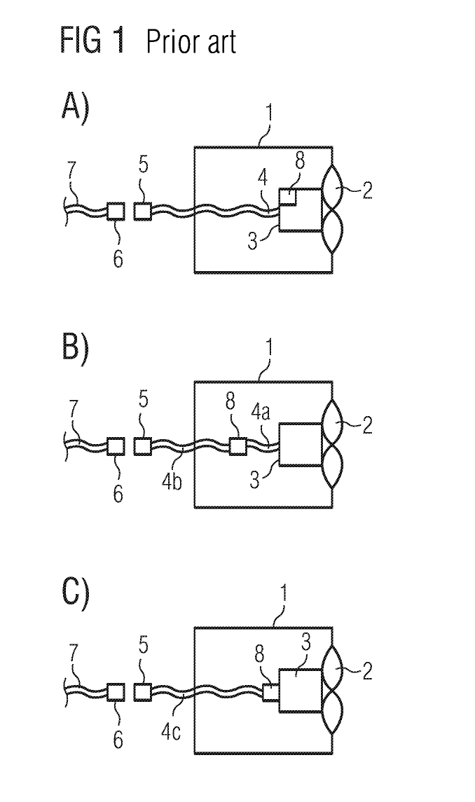

### DETAILED DESCRIPTION

According to various embodiments, the rod-shaped housing in which the device for providing pulse-width-modulated power pulses is at least partially accommodated can be used in a fan at least partially for spanning the impeller radius of the fan wheel. Consequently, in contrast to the prior art, no connecting cables are necessary in the area of the fan wheel. Accordingly no complicated cable routing is required and cables are not subject to conduction losses or chafing problems.

Preferably at least one of the narrow-side end areas of the rod-shaped housing is connected to a plug connector which is an integral part of the housing or is injection-molded onto said housing. Said plug connector can be directly contacted to a mating connector of the motor and/or of the vehicle electrical system. As a result no loose plug connectors, seals, cables and cable protecting tubes are required. This removes the need for sealing measures at openings, welded joints and other contact points.

If the plug connector is embodied as offset, according to an embodiment, then it is also possible to contact mating connectors whose insertion direction does not run in the axial direction of the housing.

If a stamped grid is disposed in the rod-shaped housing, then the plug connector contacts of the plug connector can be components of the stamped grid which are bent outward from said stamped grid.

The impeller area of the fan is reliably and stably spanned if the rod-shaped housing is fixed to the motor housing and the fan housing securing means. Said securing means can be mating connectors, screws, clips or other latching elements.

According to an embodiment, additional components can be accommodated in the rod-shaped housing which in known devices are arranged at a different point at which constricted installation conditions are present. Said additional components can be for example interference suppression chokes which, in prior art arrangements, are disposed in the motor or plug connector. By installing said interference suppression chokes in the rod-shaped housing, in which sufficient space is available, it is possible to save space in the motor or plug connector. Said additional components can also be an ohmic resistance. The latter is required if, for example, the fan can be switched between different speed ranges by means of a switchover action in which the ohmic resistance is connected or disconnected. A relay can also be an additional component that is accommodated in the rod-shaped housing.

If, according to an embodiment, the rod-shaped housing is connected to a fixed extension piece, this facilitates mass production of the rod-shaped housing because rod-shaped housings of said type are suitable for universal use if they can be adapted to fans of different sizes in conjunction with extension pieces. For example, a rod-shaped housing is manufactured whose length is geared to a fan that is widely established on the market and has a comparatively small impeller. The same rod-shaped housing can also be used for fans with a larger impeller if it is connected to a fixed extension piece whose length and angular position are adapted to the fan that is present in each case.

According to an embodiment, the rod-shaped housing can replace one of the struts of known fans, which struts lead from the motor housing to the fan housing.

FIG. 2 is a schematic of a device 8 according to an embodiment for providing pulse-width-modulated power pulses for the motor of a fan. The device shown contains as essential circuit components a processing unit 9 and at least one power output stage 10 which are connected to each other by way of a conductor network 11 having conductor tracks. As an alternative to a conductor network, the component 11 may also be a stamped grid. The processing unit 9, the power output stage(s) and the conductor network are arranged in a rod-shaped housing 12 which is provided with cooling fins 13 on its longitudinal external surfaces. The length l of the rod-shaped housing 12 is equal to at least twice the width b of the rod-shaped housing. The rod-shaped housing is preferably embodied to be as thin as possible, however. For example, the length of the rod-shaped housing can also be equivalent to ten times its width. An even greater length-to-width ratio is possible without difficulty. A rod-shaped housing according to various embodiments is also understood to mean an at least approximately rod-shaped housing in which the length side and/or width side can also have sections that are wider or bulge out.

A plug connector 14, 15 is also injection-molded onto each of the narrow-side end areas of the rod-shaped housing 12. Alternatively thereto, the plug connector housing can also be an integral part of the housing 12, i.e. manufactured together with the housing in a single production operation. The plug connector 14 has a plug connector housing 14a and plug connector contacts 14b. The latter are reed-shaped, flat plug connector contacts, for example. These are contacted to the conductor tracks 11 running in the interior of the housing 12. If the component 11 is a stamped grid, the reed-shaped, flat plug connector contacts 14b can be parts of the stamped grid and for example be bent outward therefrom. The plug connector 15 has a plug connector housing 15a and plug connector contacts 15b. The latter are reed-shaped, flat plug connector contacts, for example. These are contacted to the conductor tracks 11 running in the interior of the housing 12. If the component 11 is a stamped grid, the reed-shaped, flat plug connector contacts 15b can be parts of the stamped grid and, for example, be bent outward therefrom.

The plug connector 14 is provided for establishing electrical contact with a mating connector of the onboard electrical system of a vehicle, and the plug connector 15 for establishing direct electrical contact with the motor provided for driving the fan wheel. Toward that end a mating connector is installed for example in the motor housing, the plug connector contacts of which mating connector are contacted to the plug connector contacts 15b of the plug connector 15 for the purpose of establishing a connection.

The rod-shaped housing 12 with molded or integral plug connectors is a fixed, inflexible component which is provided between the motor positioned in the central area of the fan wheel and the vehicle electrical system and in particular is so long that it largely or completely spans the impeller radius of the fan wheel.

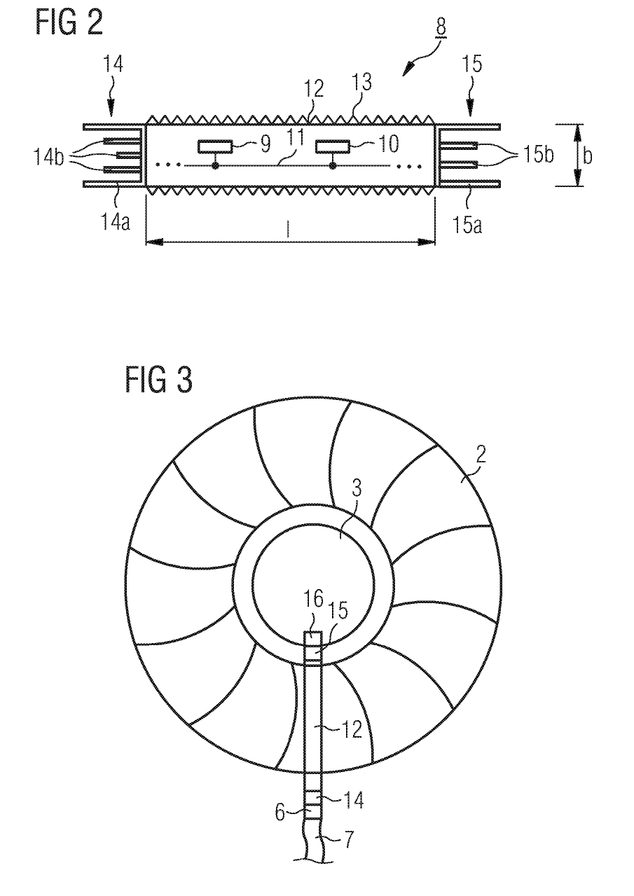

This is illustrated in FIG. 3, which shows a schematic intended to elucidate a fan according to a first exemplary embodiment. In this first exemplary embodiment the motor housing 3 is positioned in the central area of the fan wheel 2. The motor housing 3 is provided with a mating connector 16 which is mated with the plug connector 15 of the rod-shaped housing 12. The rod-shaped housing 12 completely spans the impeller radius of the fan wheel 2. The plug connector 14 provided at the other end of the rod-shaped housing 12 is mated with a mating connector 6 of the vehicle electrical system 7. Originating from a control device (not shown) of the vehicle, control signals are transmitted via the vehicle electrical system 7, the mating connector 6 and the plug connector 14 to the processing unit arranged in the rod-shaped housing 12. The latter converts the control signals into driver signals for the power output stage or stages which in turn generate pulse-width-modulated power pulses for the motor. Said power pulses are transmitted via the plug connector 15 and the mating connector 16 to the motor, which drives the fan wheel 2 as a function of the pulse-width-modulated power pulses.

An important advantage of this exemplary embodiment is that no connecting cables or connecting leads whatsoever are necessary between the vehicle electrical system or the mating connector 6 and the motor housing 3. The entire distance between the mating connector 16 on the motor housing 3 and the mating connector 6 on the vehicle electrical system 7 is spanned by the fixed, inflexible, rod-shaped housing 12 of the device for providing pulse-width-modulated power pulses. The two plug connectors 15 and 14 which are inserted into the mating connectors 16 and 6 preferably serve as securing elements for the rod-shaped housing 12. Other securing elements can also be used, however.

FIG. 4 shows a schematic intended to elucidate a fan according to a second exemplary embodiment. In this second exemplary embodiment the motor housing 3 is also positioned in the central area of the fan wheel 2. The motor housing 3 is provided with a mating connector 16 which is mated with the plug connector 15 of the rod-shaped housing 12. The rod-shaped housing 12 spans a wide section of the radius of the fan wheel, the radius of the fan wheel being greater than the radius of the fan wheel shown in FIG. 3. The plug connector 14 provided at the other end of the rod-shaped housing 12 is mated with a mating connector 17 of an extension piece 18. The extension piece 18 is likewise a fixed, inflexible, rod-shaped housing component which, together with the rod-shaped housing 12, spans the area between the motor housing 3 and the mating connector 6 of the vehicle electrical system 7 and hence also the impeller radius. The plug connector 19 of the extension pieces 18 is mated with the mating connector 6 of the vehicle electrical system 7. The two plug connectors 15 and 19 which are plugged into the mating connectors 16 and 6 serve as securing elements for the rod-shaped housing 12 and the extension piece 18 mated therewith. Other securing elements can also be used, however.

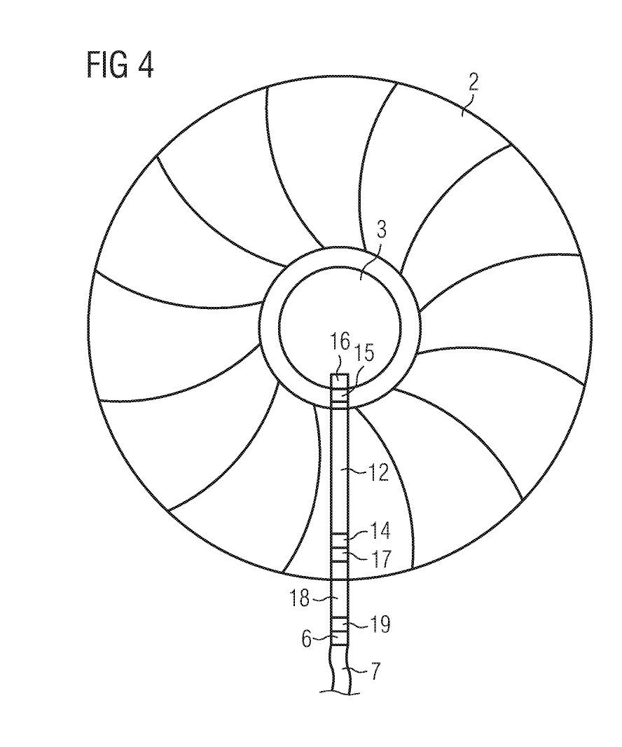

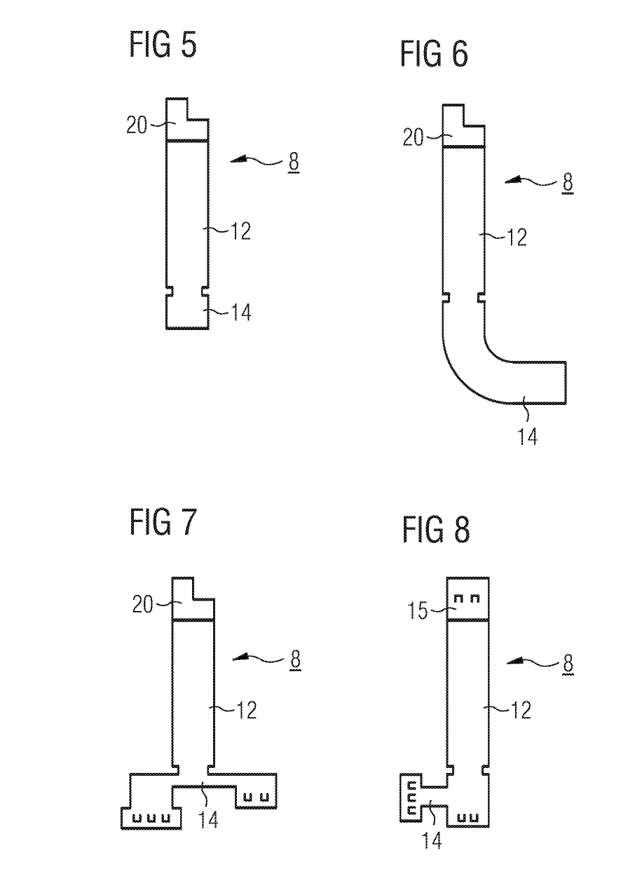

FIG. 5 shows a schematic of a second embodiment of a device 8 for providing pulse-width-modulated power pulses for the motor of a fan. In this second embodiment one of the narrow-side end areas of the rod-shaped housing 12 is provided with a plug connector 14 which is injection-molded onto the housing 12 or is an integral part of the same. In the same way as in the case of the above-described devices, the insertion direction of said plug connector 14 runs in the longitudinal direction of the housing 12. The plug connector 14 is provided for the purpose of establishing electrical contact with a mating connector of the onboard electrical system of a vehicle. The other narrow-side end area of the rod-shaped housing 12 is provided with a plug connector 20 which is injection-molded onto the housing 12 or is an integral part of the same. Said plug connector 20 is embodied as right-angled or offset. It can be mated with a mating connector on the motor side whose insertion direction deviates from the longitudinal direction of the rod-shaped housing 12.

Alternatively to the embodiment shown in FIG. 5 the plug connector 14 on the vehicle electrical system side can also be embodied as offset or right-angled. Furthermore both plug connectors 14 and 20 can also be embodied as offset or right-angled.

FIG. 6 shows a schematic of a third embodiment of a device 8 for providing pulse-width-modulated power pulses for the motor of a fan. In this third embodiment one of the narrow-side end areas of the rod-shaped housing 12 is provided with a plug connector 14 which is injection-molded onto the housing 12. The plug connector 14 is embodied as curved. The insertion direction of said plug connector 14 runs for example at an angle of 90° to the longitudinal direction of the housing 12. The plug connector 14 is provided for the purpose of establishing electrical contact with a mating connector of the onboard electrical system of a vehicle. The other narrow-side end area of the rod-shaped housing 12 is provided with a plug connector 20 which is injection-molded onto the housing 12 or is an integral part of the same. Said plug connector 20 is embodied as right-angled or offset. It can be mated with a mating connector on the motor side whose insertion direction deviates from the longitudinal direction of the rod-shaped housing 12.

Alternatively to the embodiment shown in FIG. 6 the plug connector 20 on the motor side can also be embodied as curved, or only the plug connector 20 on the motor side can be embodied as curved.

FIG. 7 shows a schematic of a fourth embodiment of a device 8 for providing pulse-width-modulated power pulses for the motor of a fan. In this fourth embodiment one of the narrow-side end areas of the rod-shaped housing 12 is provided with a plug connector 14 which is injection-molded onto the housing 12. Said plug connector 14 is a dual plug connector, as can be used for dual fans. One plug connector part of said dual plug connector is provided for contacting with a mating connector of the vehicle electrical system. The other plug connector part serves for contacting with a mating connector which is assigned to a second fan motor. The insertion direction of the two plug connector parts of the plug connector 14 shown in FIG. 7 is the longitudinal direction of the rod-shaped housing 12. The other narrow-side end area of the rod-shaped housing 12 is provided with a plug connector 20 which is injection-molded onto the housing 12 or is an integral part of the same. Said plug connector 20 is embodied as right-angled or offset. It can be mated with a motor-side mating connector whose insertion direction deviates from the longitudinal direction of the rod-shaped housing 12.

FIG. 8 shows a schematic of a fifth embodiment of a device 8 for providing pulse-width-modulated power pulses for the motor of a fan. In this fifth embodiment one of the narrow-side end areas of the rod-shaped housing 12 is provided with a plug connector 14 which is injection-molded onto the housing 12. Said plug connector 14 is a dual plug connector of the kind that can be used for dual fans. One plug connector part of said dual plug connector is provided for contacting with a mating connector of the vehicle electrical system. The other plug connector part serves for contacting with a mating connector which is assigned to a second fan wheel. The insertion direction of one plug connector part of the plug connector 14 runs in the longitudinal direction of the rod-shaped housing 12. The insertion direction of the other plug connector part of the plug connector 14 runs for example at an angle of 90° to the longitudinal direction of the rod-shaped housing 12. The other narrow-side end area of the rod-shaped housing 12 is provided with a plug connector 15 which is injection-molded onto the housing 12 or is an integral part of the same. The insertion direction of the plug connector 15 runs in the longitudinal direction of the rod-shaped housing 12. The plug connector 15 can be mated with a motor-side mating connector whose insertion direction is also the longitudinal direction of the rod-shaped housing 12.

Alternatively to the embodiment shown in FIG. 8 the plug connector 15 can also be embodied as offset or right-angled.

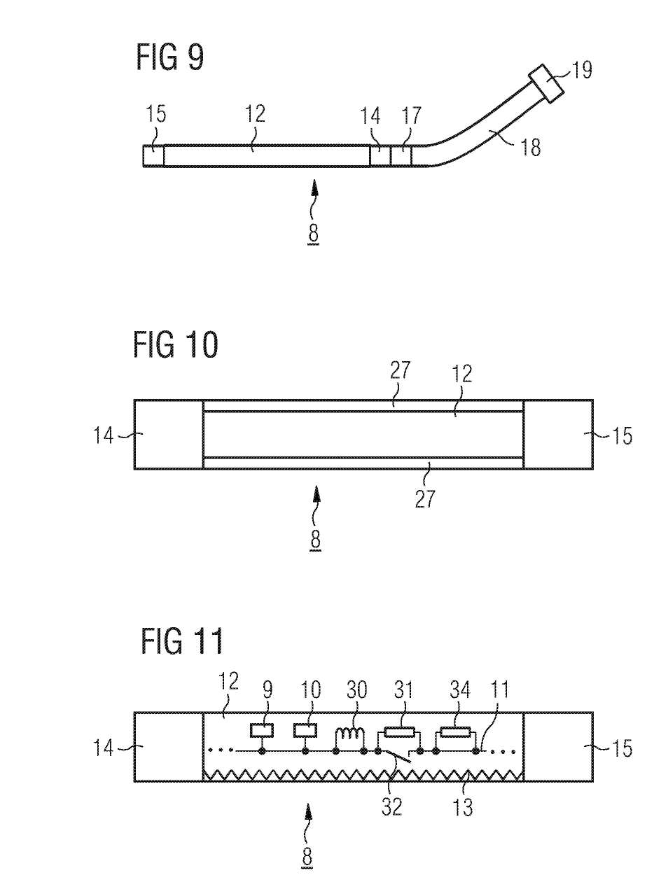

FIG. 9 shows a schematic of a sixth embodiment of a device 8 for providing pulse-width-modulated power pulses for the motor of a fan. In this sixth embodiment one of the narrow-side end areas of the rod-shaped housing 12 is provided with a plug connector 14 which is injection-molded onto the housing 12 or is an integral part of the same. The insertion direction of said plug connector 14 runs in the longitudinal direction of the housing 12. The plug connector 14 is provided for contacting with a mating connector 17 of a fixed, inflexible extension piece 18. The extension piece 18 is embodied as curved and is provided in its other end area with a plug connector 19. The latter serves for contacting with a mating connector of the vehicle electrical system, the insertion direction of the mating connector of the vehicle electrical system deviating from the longitudinal direction of the rod-shaped housing 12 and the distance between the plug connector 14 of the rod-shaped housing 12 and the mating connector of the vehicle electrical system having to be spanned by means of a second component. The other narrow-side end area of the rod-shaped housing 12 is provided with a plug connector 15 which is injection-molded onto the housing 12 or is an integral part of the same. The insertion direction of the plug connector 15 coincides with the longitudinal direction of the rod-shaped housing 12. The plug connector 15 can be mated with a motor-side mating connector whose insertion direction is also the longitudinal direction of the rod-shaped housing 12.

Alternatively to the embodiment shown in FIG. 9 the plug connector 15 can also be embodied as offset or right-angled.

FIG. 10 shows a further embodiment of a device for providing pulse-width-modulated power pulses for the motor of a fan. In this further embodiment the rod-shaped housing 12 is provided in its narrow-side end areas with plug connectors 14, 15, the plug connector 14 being provided for contacting with a mating connector of the vehicle electrical system and the plug connector 15 being provided for contacting with a mating connector provided on the motor housing. In this further embodiment the housing 12 is also enclosed by a metal sheath 27. The advantage of said metal sheath, which can also be provided for all the above-described embodiments or exemplary embodiments, consists in the fact that no antenna effect with high radiation occurs during operation and the susceptibility to irradiation is also greatly reduced.

FIG. 11 shows a further embodiment of a device for providing pulse-width-modulated power pulses for the motor of a fan. In this further embodiment the rod-shaped housing 12 has plug connectors 14 and 15 in its narrow-side end areas. The plug connector 14 serves for contacting with a mating connector of the vehicle electrical system, while the plug connector 15 is provided for contacting with a mating connector on the motor housing. The rod-shaped housing 12 is provided with inward-directed cooling fins 13. Also provided within the housing 12 apart from the processing unit 9, at least one power output stage 10 and the stamped grid or, as the case may be, conductor network 11 are at least one interference suppression choke 30 and an ohmic resistance 31. The interference suppression choke 30 is typically provided in the motor or plug connector. However, since constricted installation conditions prevail there, the interference suppression choke is positioned in the rod-shaped housing 12, where sufficient space is available. The ohmic resistance 31 can be connected and disconnected by means of a switch 32 in order to implement a fan which can operate in two speed ranges. A relay 34 can also be accommodated in the rod-shaped housing 12.

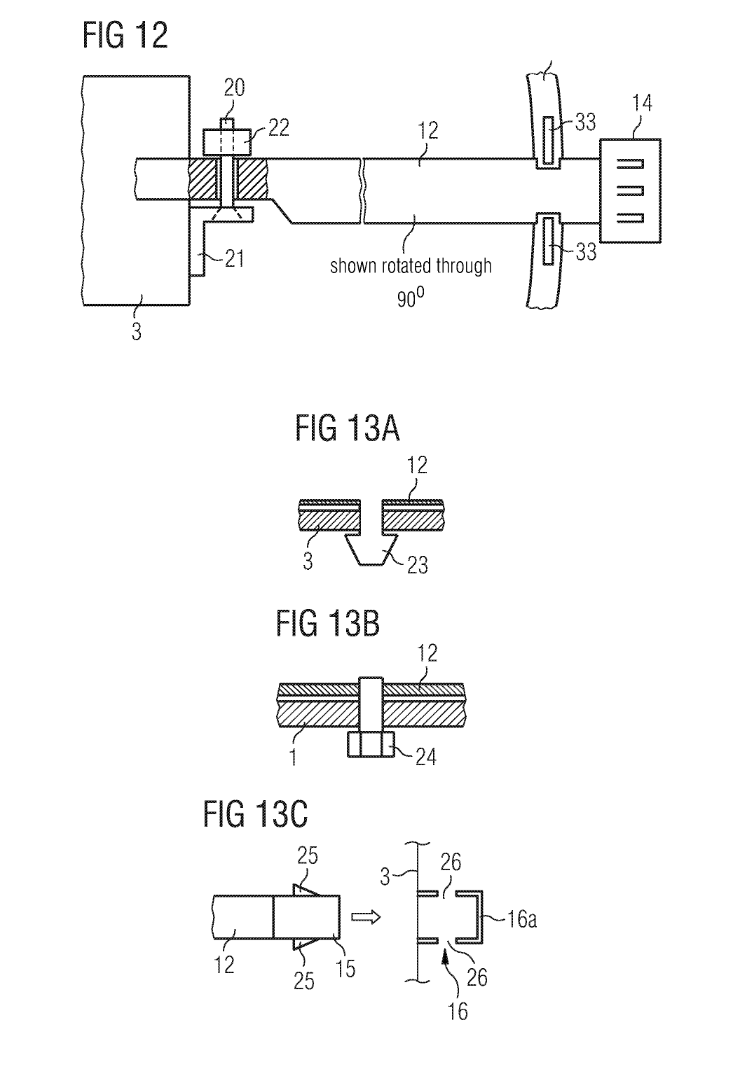

FIG. 12 shows a schematic intended to elucidate a further exemplary embodiment for connecting a device for providing pulse-width-modulated power pulses for the motor of a fan to the motor housing 3 and the fan housing 1. In this further exemplary embodiment the rod-shaped housing 12 is provided in one of its narrow-side end areas with a plug connector 14 which is injection-molded onto the housing 12 or is an integral part of the same. Said plug connector 14 is provided for contacting with a mating connector of the vehicle electrical system. In the other narrow-side end area the rod-shaped housing 12 is screw-connected using screws 20 to a bracket 21 and a fastening ring 22 of a bracket provided on the motor housing 3. The fastening ring 22 is mounted on the air scoop of the fan housing 1. The fan housing has a clip 33 which engages into a groove of the rod-shaped housing 12. The right-hand part of the drawing in FIG. 12 is shown rotated through 90° for the purposes of illustration.

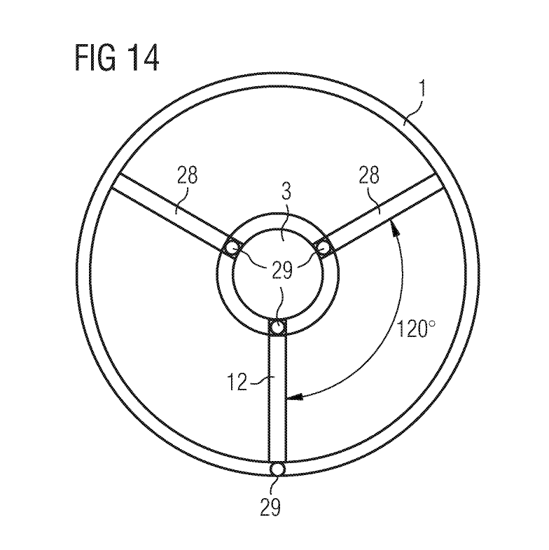

FIG. 13 shows schematics intended to elucidate further securing means by means of which the rod-shaped housing 12 can be secured to the motor housing or to the fan housing. Said securing means are arranged on the outer circumference of the rod-shaped housing 12, preferably in the vicinity of its narrow-side end areas.

According to FIG. 13a there is provided on the outer circumference of the rod-shaped housing 12 a fir-tree-shaped catch 23 by means of which the rod-shaped housing 12 is secured to the motor housing 3. According to FIG. 13b the rod-shaped housing 12 is secured to the fan housing 1 by means of screws 24. According to FIG. 13c the rod-shaped housing 12 is provided at one of its narrow-side end areas with a plug connector 15 which has latching lugs 25 on its outside faces. When said plug connector 15 is inserted into a mating connector provided on the motor housing 3, the latching lugs 25 snap into latching grooves 26 which are provided in the plug connector housing 16a of the mating connector 16.

FIG. 14 shows a further exemplary embodiment intended to elucidate a fan, according to which exemplary embodiment one of the struts by means of which the motor housing is secured is replaced by the rod-shaped housing 12. In this case the figure shows the motor housing 3 to which two conventional struts 28 and the rod-shaped housing 12 are secured by means of screws 29. In this arrangement the external shape of the rod-shaped housing 12 approximately corresponds to the external shape of a strut 28. In its other end area in each case the rod-shaped housing 12 is secured to the fan housing 1 by means of further screws or other connecting elements. In this exemplary embodiment the two struts 28 and the rod-shaped housing 12 are in each case offset relative to each other by an arbitrary angle, by an angle of 120° for example. Since the rod-shaped housing 12 is used in this exemplary embodiment as a replacement for a strut, no additional space is required for the rod-shaped housing 12 on the motor housing and on the fan housing or on its air scoop.

A further advantage of a fan that has a device according to an embodiment consists in the fact that the rod-shaped housing can be arranged directly in the air stream of the fan wheel, with the result that a good dissipation of the heat generated by the power output stages is given. Also, only a slight obstruction of the air occurs, since the surface area of the rod-shaped housing that lies in the air stream is small. A further advantage consists in the improved ability to automate the production of a fan, since no complicated and time-consuming running or routing of connecting cables is necessary.

Alternatively the plug connection 15/16 on the motor in all the above-cited exemplary embodiments can be replaced by a welded connection of contact lugs of the rod-shaped housing to in each case associated conductor tracks in the motor.

What is claimed is:

1. A device for providing pulse-width-modulated power pulses for the motor of a fan, comprising
a processing unit and
at least one power output stage,
wherein the processing unit and the power output stage are arranged in a rod-shaped housing.

2. The device according to claim 1, wherein the length of the rod-shaped housing is equivalent to at least twice the width of the rod-shaped housing.

3. The device according to claim 1, wherein at least one of the narrow-side end areas of the housing is provided with a plug connector which has a plug connector housing and plug connector contacts.

4. The device according to claim 3, wherein the plug connector housing is part of the rod-shaped housing.

5. The device according to claim 3, wherein at least one of the narrow-side end areas of the housing has an offset plug connector.

6. The device according to claim 1, wherein a stamped grid is arranged in the rod-shaped housing and the plug connector contacts of the plug connector are component parts of the stamped grid.

7. The device according to claim 1, wherein a stamped grid is arranged in the rod-shaped housing and the plug connector contacts of the plug connector are connected to the stamped grid.

8. The device according to claim 1, wherein the rod-shaped housing has securing means on its outer circumference.

9. The device according to claim 8, wherein the securing means are the plug connectors or latching means or securing brackets.

10. The device according to claim 1, wherein the rod-shaped housing is provided with a metal sheath.

11. The device according to claim 1, wherein at least one additional component is also contained in the rod-shaped housing.

12. The device according to claim 11, wherein one additional component is an interference suppression choke.

13. The device according to claim 11, wherein one additional component is an ohmic resistance and/or a relay.

14. A fan comprising a motor, a fan wheel and a device for providing pulse-width-modulated power pulses comprising a processing unit and at least one power output stage, wherein the device for providing pulse-width-modulated power pulses is arranged in a rod-shaped housing.

15. The fan according to claim 14, wherein the length of the rod-shaped housing is equivalent to at least twice the width of the rod-shaped housing.

16. The fan according to claim 14, wherein at least one of the narrow-side end areas of the rod-shaped housing is contacted to the motor housing without the use of a connecting cable.

17. The fan according to claim 16, wherein the narrow-side end area of the rod-shaped housing contacted to the motor housing has a plug connector which is directly contacted to a mating connector of the motor housing.

18. The fan according to claim 14, wherein the motor is positioned in the central area of the fan wheel and the rod-shaped housing completely or largely spans the impeller radius of the fan wheel.

19. The fan according to claim 14, wherein the motor is positioned in the central area of the fan wheel, the rod-shaped housing is connected to a fixed extension piece and the rod-shaped housing together with the fixed extension piece connected thereto spans the impeller radius of the fan wheel.

20. The fan according to claim 14, wherein the motor housing is connected to the fan housing by means of struts and the rod-shaped housing serves as a strut.

21. The fan according to claim 14, wherein the motor housing is secured to the fan housing by means of a bracket and a fastening ring and the rod-shaped housing is secured to the motor bracket and the fastening ring.

22. The fan according to claim 21, wherein the rod-shaped housing is connected to the motor bracket and the fastening ring by means of screws.

23. The fan according to claim 14, wherein the rod-shaped housing is provided with a metal sheath.
